(19) United States
(12) Patent Application Publication
(10) Pub. No.: US 2006/0085258 A1
(43) Pub. Date: Apr. 20, 2006

(54) Computer implemented incentive compensation distribution system and associated methods

(76) Inventor: Joel O. Montgomery, Tallahassee, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/254,331

(22) Filed: Oct. 20, 2005

Related U.S. Application Data
(60) Provisional application No. 60/620,777, filed on Oct. 20, 2004.

(51) Int. Cl. G06Q 30/00

(52) U.S. Cl. 705/14

(57) ABSTRACT

A computer implemented incentive compensation distribution system is for a plurality of revenue units of a business also including a home office supplying administrative services to the revenue units. The system may include a distribution module for calculating respective home office administrative services utilized by the revenue units. The distribution module may calculate individual performance scores for individuals within the revenue units with each individual performance score being based upon performance relative to a respective individual performance benchmark, and respective revenue unit performance scores with each performance score being based upon an average of individual performance scores within the revenue unit. The distribution module may also allocate an authorized reward among the revenue units and the individuals within the revenue units based upon the calculated home office services utilized and the revenue unit and the individual performance scores.

### RELATED APPLICATION

This application is based upon prior filed copending provisional application Ser. No. 60/620,777 filed Oct. 20, 2004, the entire subject matter of which is incorporated herein by reference in its entirety.

### FIELD OF THE INVENTION

The invention relates to the field of computer implemented management systems, and, more particularly, to incentive management systems and related methods.

### BACKGROUND OF THE INVENTION

Different management systems attempt to ensure that human and financial resources of a business are being applied in the most effective and efficient way possible. As a result, one goal of many of these management systems is to provide a fair compensation package that supports long-term retention of workers while also enhancing the productivity and quality of the work performed. In order to achieve a fair compensation package, management usually has to measure and rate job performance to determine the compensation package for a given individual. In an attempt to reduce subjectivity from such a determination, different management systems have developed an array of objective measures to quantify individual performance.

For example, the incentive plan instituted at the North Florida Medical Centers (NFMC) by the inventor of the present application uses a pool of money earned from a previous accounting period to determine a bonus money pool available for a present accounting period. NFMC then evaluates each employee's performance relative to the actualization of predetermined objectives as measured against 100% compliance standards and in view of their value to NFMC relative to the employee's market value and of their colleagues. The employee's reward is then adjusted accordingly by two modifiers such as Unbillable Accounts and Lost Revenue-Prior Periods, which have an impact on the bonus money awarded. Individual scores of less than 100% equate to dollars left on the table, which are then reallocated to all eligible participants based on individual scores.

U.S. Pat. No. 6,901,301 to Bradshaw discloses a computerized evaluation system in which an entity such as an individual or organization can be held accountable for decisions and implementations of those decisions made during the execution of job duties. The system includes a database cooperating with an evaluation unit to provide a structured process by which the analysis of the decisions and execution of the decisions may simplify personnel evaluations.

U.S. Pat. No. 6,742,002 to Arrowood discloses a computerized system for assisting in the staffing of a project for a client. The system includes a database cooperating with a plurality of interfaces to collect employee data and to provide a report regarding employee parameters such as references, evaluations, skill set, and the like to a potential client.

U.S. Pat. No. 6,859,523 to Jilk et al. discloses a computerized system for managing remote workers and assessing the work product produced by the workers. The system includes a database cooperating with a task management system to recruit for, and assign work to, a particular entity as well as to evaluate the work product.

Unfortunately, conventional management systems may be unable to provide fair compensation packages to workers while also compensating for business considerations that impact the viability of the employer.

### SUMMARY OF THE INVENTION

In view of the foregoing background, it is therefore an object of the invention to provide a system and method for structuring fair worker compensation packages based upon an authorized reward while taking into account business considerations.

This and other objects, features, and advantages in accordance with the invention may be provided by a computer implemented compensation distribution system for at least one of a plurality of revenue units of a business also including a home office supplying administrative services to the revenue units. The system may include a database having stored therein an authorized reward based upon a portion of profit or loss for the revenue units. A distribution module may be connected to the database for calculating respective home office administrative services utilized by the revenue units.

The distribution module may calculate respective revenue unit performance scores. The distribution module may also calculate individual performance scores for individuals within the revenue units, and each individual performance score being based upon performance relative to a respective individual performance benchmark. The distribution module may also allocate the authorized reward among the revenue units and the individuals within the revenue units based upon the calculated home office services utilized by the revenue unit and the individual performance scores. Accordingly, the system may provide for structuring fair worker compensation packages based upon an authorized reward while taking into account business considerations.

The distribution module may calculate the home office administrative services utilized by determining the portion of home office administrative services used by each revenue unit and reducing each revenue unit's portion of the authorized reward by the portion of home office administrative services utilized. The distribution module may calculate a portion of the authorized reward for the home office by adding respective portions of the authorized reward reduced from each revenue unit's authorized reward.

The distribution module may redistribute portions of the authorized reward not distributed to individuals with a performance score below an acceptable level to the individuals with performance scores at or above the acceptable level. The distribution module may calculate the portion of the authorized reward for each revenue unit by multiplying a number of revenue production units by a modifier. The authorized reward may not be based upon a percentage of a revenue unit's profit.

The distribution module may calculate each performance score using at least one of a measurement of employee productivity, a measurement of improvement in client satisfaction, a measurement of cost reduction to the revenue unit, and a measurement of client access to business services. The distribution module may calculate expenses for each revenue unit without including expenses that are not common to each revenue unit. The computer implemented compensation distribution system may further comprise a user interface module cooperating with the database for prompting and receiving at least one of the authorized reward, revenue unit expenses, individual performance scores and revenue unit performance scores.

Another aspect is directed to a method for using a computer implemented compensation distribution system for at least one of a plurality of revenue units of a business including a home office supplying administrative services to the revenue units. The method may comprise calculating respective home office administrative services utilized by the revenue units. The method may also comprise calculating respective revenue unit performance scores with each performance score being based upon performance relative to a respective revenue unit performance benchmark. The method may further comprise calculating individual performance scores for individuals within the revenue units, and each individual performance score being based upon performance relative to a respective individual performance benchmark. The method may also comprise allocating an authorized reward among the revenue units and the individuals within the revenue units based upon the calculated home office services utilized and the revenue unit and the individual performance scores.

### BRIEF DESCRIPTION OF THE DRAWINGS

FIG. 1 is block diagram of the compensation distribution system in accordance with the invention.

FIG. 2 is a flowchart illustrating a method according to the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

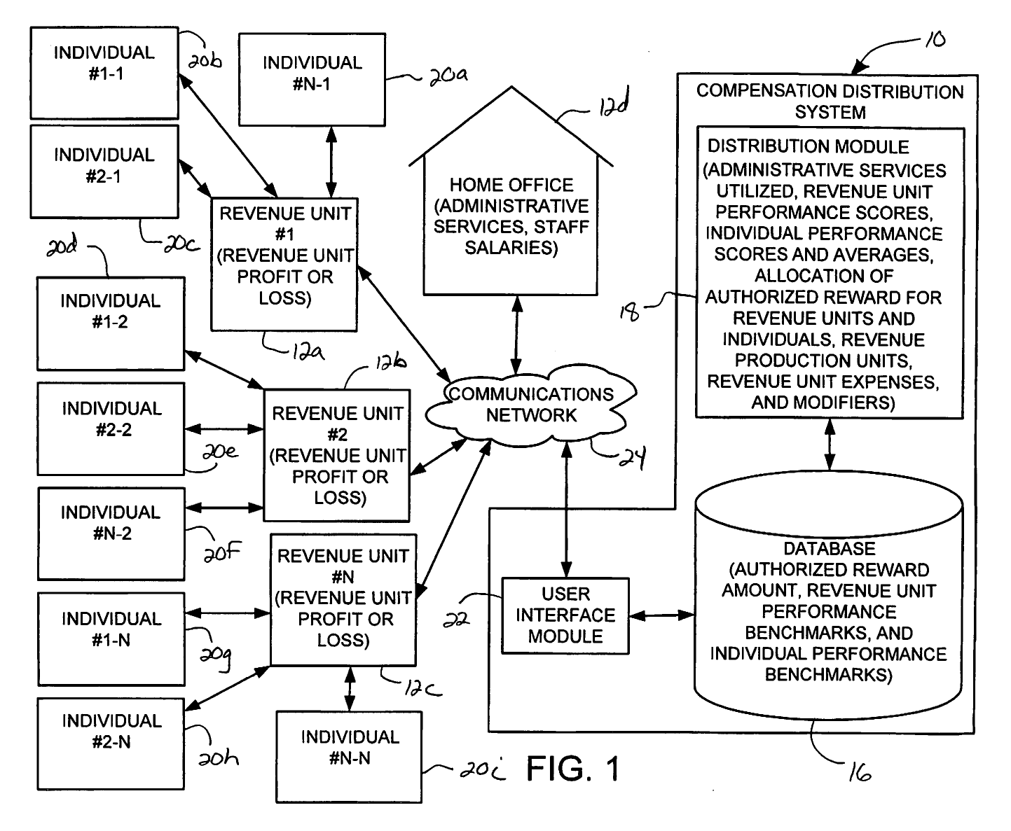

Referring initially to FIG. 1, a computer implemented compensation distribution system 10 in accordance with the invention is now described. The compensation distribution system 10 is for at least one of the illustrated plurality of revenue units 12a-12d of a business that includes a home office 12d supplying administrative services to the revenue units.

Home office 12d staff provides indispensable support services to each revenue unit 12a-12c and is considered an integral member of the revenue unit's team. Without home office 12d support, each revenue unit 12a-12c would essentially have to duplicate accounting, personnel, payroll, billing, purchasing, recruitment, business development, administrative and management information services, and the like. Even though the home office 12d staff does not generate revenue, home office support services are crucial to the success of each revenue unit 12a-12c thus necessitating a mechanism for determining the home office reward allocation.

The compensation distribution system 10 also includes a database 16 having stored therein an authorized reward based upon a portion of profit or loss for the revenue units 12a-12d. The authorized reward is established by the governing body, and is based on the needs and financial resources of the business and the financial performance of the revenue units. The amount of authorized reward is not the result of a formula whereby each revenue unit receives a certain percent of their profit or dollars per productive unit.

The authorized reward is subject to available resources, future cash needs, and may vary from one period to the next. Regardless of the financial performance of the business, cash rewards for any one or more periods may not be authorized if resources are not available or if the cash is designated for other purposes. The authorized reward may be reduced or eliminated if financial conditions change or the business experiences significant business reversals. Generally company wide profits in the current period translate to future rewards. Likewise, losses in the current period translate to lower or no future rewards. By relying on the authorized reward, cash allocations are under the control of management and the governing body.

In addition, the authorized reward may not be based upon a percentage of a revenue unit's 12a-12c profit. For example, a revenue unit 12a-12c that records a loss for a distribution period may still be eligible to receive a portion of the authorized reward if the revenue unit's financial performance exceeds a certain threshold relative to other revenue units 12a-12c.

A distribution module 18 is connected to the database 16 for calculating respective home office 12d administrative services utilized by the revenue units 12a-12c. For example, the total market value of all job titles worked at each revenue unit 12a-12c is determined to establish the relative portion of home office administrative services utilized by each revenue unit 12a-12c. The distribution module 18 may calculate the home office 12d administrative services utilized by determining the relative portion of home office administrative services utilized by each revenue unit 12a-12c and reduce each revenue unit's portion of the authorized reward by the relative portion of home office administrative services utilized.

The relative administrative support services the home office makes to a particular revenue unit 12a-12c determines what portion of the revenue unit's authorized reward should go to the home office 12d. In other words, the distribution module 18 may calculate a portion of the authorized reward for the home office 12d by adding respective portions of the authorized reward reduced from each revenue unit's 12a-12c authorized reward.

The distribution module 18 calculates respective revenue unit 12a-12c performance scores with each performance score being based upon the average of individual performance scores within each revenue unit. For example, individual performance benchmarks are determined based upon historical performance data, growth estimates, comparables to similar revenue units, and the like. The distribution module 18 calculates each performance score using at least one of a measurement of employee productivity, a measurement of improvement in client satisfaction, a measurement of cost reduction to the revenue unit 12a-12c, a measurement of client access to business services, and the like as will be appreciated by those of skill in the art.

The distribution module 18 calculates individual performance scores for individuals 20a-20i within the revenue units 12a-12c. Each individual performance score is based upon performance relative to a respective individual performance benchmarks. For example, the individual performance benchmarks are determined based upon historical performance data, growth estimates, comparables to individuals in similar jobs, and the like. The individual performance score is based upon such things as productivity, each individual's relative contribution to the business, and the like.

The distribution module 18 allocates the authorized reward among the revenue units 12a-12c and the individuals 20a-20i within the revenue units based upon the calculated home office 12d administrative services utilized by the revenue units, revenue units 12a-12c performance scores, and the individual performance scores. In some embodiments, the distribution module 18 calculates the portion of the authorized reward for each revenue unit 12a-12c and employee 20a-20i based upon a modifier.

The equitable distribution of portions of the authorized reward to each revenue unit 12a-12c and the eligible individuals 20a-20i is accomplished by utilizing the modifier. The modifier determines if any portion of the authorized reward is to be added to each revenue unit 12a-12c. The modifier is used to balance (match) actual rewards with the total authorized. In addition to reward allocations, the modifier impacts each revenue unit 12a-12c in one of three ways: reduces the revenue unit's loss, converts the revenue unit's loss to an inflated profit or inflates (increases) revenue unit's profit. The modifier's value is subject to the authorized reward, revenue unit performance scores, each individual's 20a-20i relative contribution and performance scores and other variable factors. The value of the modifier is therefore unique in every allocation of the authorized reward.

The modifier also serves as a mechanism for distributing unclaimed rewards to all eligible individuals 20a-20i. For example, if one individual 20a-20i had an overall score of 100%, this individual would claim every dollar he or she was initially awarded. Likewise, if an individual 20a-20i scored at the 50% level, this individual would receive approximately 50% of their potential allocation. The remainder would be distributed to every eligible individual 20a-20i based on their individual performance, including a portion to the individual who scored at the 50% level. Consequently, the distribution module 18 redistribute portions of the authorized reward not distributed to individuals 20a-20i with a performance score below an acceptable level to the individuals with performance scores at or above the acceptable level.

In addition, qualifying conditions may be established for reward eligibility. A minimum productivity score of 70% may be required of all individuals 20a-20i. Failure to meet the 70% target disqualifies the individual 20a-20i from any rewards for the period in which that performance goal has not been met.

The distribution module may calculate expenses for each revenue unit 12a-12c without including expenses that are not common to each revenue unit. For example, some revenue units 12a-12c incur rent payments, while others enjoy free rent or are housed in a debt free building. Under these conditions, profit or loss calculations do not include the value of in-kind contributions, amortization, principal payments, interest, rent, lease expenses, or the like. This accounting procedure levels the playing field when calculating each revenue unit's “profit” or “loss” for the period under review.

Accordingly, the compensation distribution system 10 is for structuring fair worker compensation packages based upon an authorized reward while taking into account business considerations. Further, the compensation distribution system 10 offers an opportunity for higher performing individuals 20a-20i to earn recognition and wages at or above the market maximum average for their respective positions.

The compensation distribution system 10 may further comprise a user interface module 22 cooperating with the database 16 for prompting and receiving at least one of the authorized reward, revenue unit expenses, individual performance scores, revenue unit profit or loss, and revenue unit performance scores. The user interface module 22 is connected to a communications network 24, which is a wired and/or wireless system such as the Internet, local area network, and the like as will be appreciated by those of skill in the art.

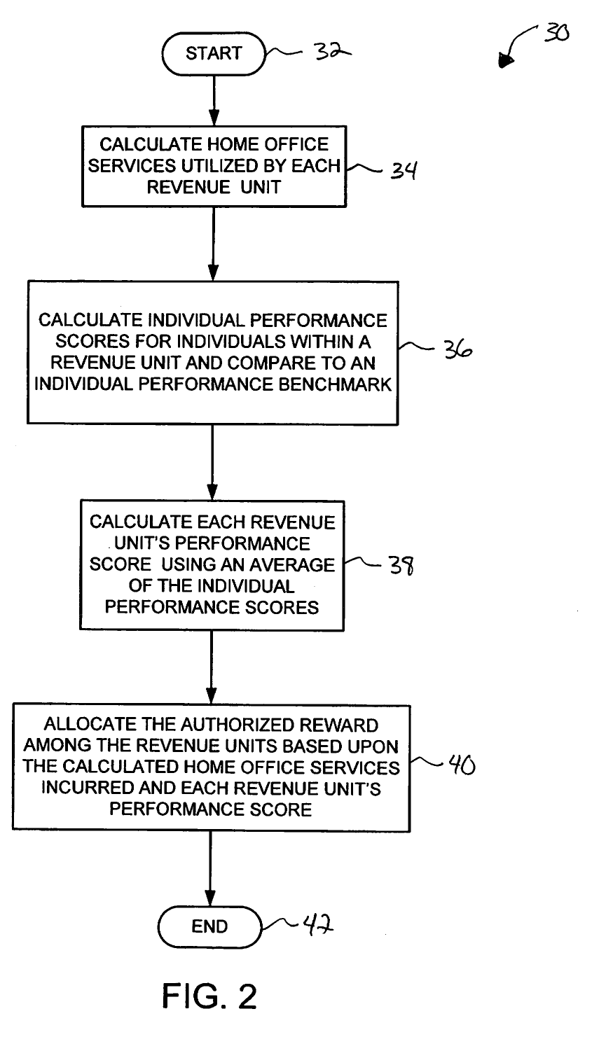

Another aspect is directed to a method for using a computer implemented compensation distribution system 10 for at least one of a plurality of revenue units 12a-12c of a business including a home office 12d supplying administrative services to the revenue units, which is now described with referenced to the flowchart 30 of FIG. 2. The compensation distribution system 10 may comprise a database 16 having stored therein an authorized reward based upon a portion of profit or loss for the revenue units 12a-12c, and a distribution module 18 connected to the database. The method begins at Block 32. The method comprises calculating respective home office 12d administrative services utilized by the revenue units 12a-12c at Block 34. The method may also comprise calculating individual performance scores for individuals 20a-20i within the revenue units 12a-12c, and each individual performance score being based upon performance relative to a respective individual performance benchmarks at Block 36. The method further comprises calculating respective revenue units 12a-12c performance scores with each revenue performance score being based upon an average of individual performance scores within the revenue unit at Block 38. The method may also comprise allocating the authorized reward among the revenue units 12a-12c and the individuals 20a-20i within the revenue units based upon the calculated home office services utilized by the revenue unit and the individual performance scores at Block 40. The method ends at Block 42.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A computer implemented compensation distribution system for at least one of a plurality of revenue units of a business also including a home office supplying administrative services to the revenue units, the system comprising:
a database having stored therein an authorized reward based upon a portion of profit or loss for the revenue units; and
a distribution module connected to the database for
calculating respective home office administrative services used by each revenue unit,
calculating individual performance scores for individuals within the revenue units, and each individual performance score being based upon performance relative to a respective individual performance benchmark,
calculating respective revenue unit performance scores with each performance score being based upon an average of individual performance scores within the revenue unit, and
allocating the authorized reward among the revenue units and the individuals within the revenue units based upon the calculated home office services utilized and the revenue unit and the individual performance scores.

2. The computer implemented compensation distribution system according to claim 1 wherein said distribution module calculates the home office administrative services utilized by determining the total market value of all job titles worked at each revenue unit to establish the relative portion of home office administrative services utilized by each revenue unit and reducing each revenue unit's portion of the authorized reward by the relative portion of home office administrative services utilized.

3. The computer implemented compensation distribution system according to claim 2 wherein said distribution module calculates a portion of the authorized reward for the home office by adding respective portions of the authorized reward reduced from each revenue unit's authorized reward.

4. The computer implemented compensation distribution system according to claim 1 wherein said distribution module redistributes portions of the authorized reward not distributed to individuals with a performance score below an acceptable level to the individuals with performance scores at or above the acceptable level.

5. The computer implemented compensation distribution system according to claim 1 wherein said distribution module calculates the portion of the authorized reward for each revenue unit and individual by multiplying a number of revenue production units by a modifier.

6. The computer implemented compensation distribution system according to claim 1 wherein said distribution module calculates each revenue unit performance score using at least one of a measurement of employee productivity, a measurement of improvement in client satisfaction, a measurement of cost reduction to the business, and a measurement of client access to business services.

7. The computer implemented compensation distribution system according to claim 1 further comprising a user interface module cooperating with said database for prompting and receiving at least one of the authorized reward, revenue unit profit or loss, individual performance scores and revenue unit performance scores.

8. The computer implemented compensation distribution system according to claim 1 wherein said distribution module calculates expenses for each revenue unit without including expenses that are not common to each revenue unit.

9. The computer implemented compensation distribution system according to claim 1 wherein the authorized reward is not based upon a percentage of a revenue unit's profit.

10. A computer implemented compensation distribution system for a plurality of revenue units of a business also including a home office supplying administrative services to the revenue units, the system comprising:
a database having stored therein an authorized reward based upon a portion of profit or loss for the revenue units; and
a distribution module connected to the database for
calculating respective home office administrative services utilized by each revenue unit,
calculating individual performance scores for individuals within the revenue units, and each individual performance score being based upon performance relative to a respective individual performance benchmark,
calculating respective revenue unit performance scores with each performance score being based upon an average of individual performance scores within the revenue unit,
allocating the authorized reward, which is not based upon a percentage of a revenue unit's profit, among the revenue units and the individuals within the revenue units based upon the calculated home office services utilized and the revenue unit and the individual performance scores, and
redistributing portions of the authorized reward not distributed to individuals with a performance score below an acceptable level to the individuals with performance scores at or above the acceptable level.

11. The computer implemented compensation distribution system according to claim 10 wherein said distribution module calculates the home office administrative services utilized by determining the total market value of all job titles worked at each revenue unit to establish the relative portion of home office administrative services utilized by each revenue unit and reducing each revenue unit's portion of the authorized reward by the relative portion of home office administrative services utilized.

12. The computer implemented compensation distribution system according to claim 11 wherein said distribution module calculates a portion of the authorized reward for the home office by adding respective portions of the authorized reward reduced from each revenue unit's authorized reward.

13. The computer implemented compensation distribution system according to claim 10 wherein said distribution module calculates the portion of the authorized reward for each revenue unit by multiplying a number of revenue production units by a modifier.

14. The computer implemented compensation distribution system according to claim 10 wherein said distribution module calculates each revenue unit's performance score using at least one of a measurement of employee productivity, a measurement of improvement in client satisfaction, a measurement of cost reduction to the business, and a measurement of client access to business services.

15. The computer implemented compensation distribution system according to claim 10 further comprising a user interface module cooperating with said database for prompting and receiving at least one of the authorized reward, revenue unit profit or loss, individual performance scores and revenue unit performance scores.

16. The computer implemented compensation distribution system according to claim 10 wherein said distribution module calculates expenses for each revenue unit without including expenses that are not common to each revenue unit.

17. A method for using a computer implemented compensation distribution system for a plurality of revenue units of a business also including a home office supplying administrative services to the revenue units, the method comprising:
calculating respective home office administrative services utilized by the revenue units;
calculating individual performance scores for individuals within the revenue units, and each individual performance score being based upon performance relative to a respective individual performance benchmark;
calculating respective revenue unit performance scores with each performance score being based upon an average of individual performance scores within the revenue unit; and
allocating an authorized reward among the revenue units and the individuals within the revenue units based upon the calculated home office services utilized and the revenue unit and the individual performance scores.

18. The method according to claim 17 further comprising calculating the home office administrative services utilized by determining the total market value of all job titles worked at each revenue unit to establish the relative portion of home office administrative services utilized by each revenue unit and reducing each revenue unit's portion of the authorized reward by the relative portion of home office administrative services utilized.

19. The method according to claim 17 further comprising calculating a portion of the authorized reward for the home office by adding respective portions of the authorized reward reduced from each revenue unit's authorized reward.

20. The method according to claim 17 further comprising redistributing portions of the authorized reward not distributed to individuals with a performance score below an acceptable level to the individuals with performance scores at or above the acceptable level.

21. The method according to claim 17 further comprising calculating the portion of the authorized reward for each revenue unit by multiplying a number of revenue production units by a modifier.

22. The method according to claim 17 further comprising calculating each revenue performance score using at least one of a measurement of employee productivity, a measurement of improvement in client satisfaction, a measurement of cost reduction to the business, and a measurement of client access to business services.

23. The method according to claim 17 further comprising providing a user interface module for cooperating with the database to prompt and receive at least one of the authorized reward, revenue unit profit or loss, individual performance scores and revenue unit performance scores.

24. The method according to claim 17 further comprising calculating the home office administrative expenses for each revenue unit without including expenses that are not shared by each revenue unit.

25. The method according to claim 17 wherein the authorized reward is not based upon a percentage of a revenue unit's profit.
